(19) United States
(12) Patent Application Publication
(10) Pub. No.: US 2009/0045970 A1
(43) Pub. Date: Feb. 19, 2009

(54) Remote control system, receiving apparatus, and electronic device

(75) Inventors: Naoki Miyabayashi, Tokyo (JP); Takayuki Morimatsu, Kanagawa (JP); Takashi Tsurumoto, Saitama (JP); Masahiro Nakano, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/228,026

(22) Filed: Aug. 8, 2008

(30) Foreign Application Priority Data
Aug. 16, 2007 (JP) P2007-212181

(51) Int. Cl. G05B 19/02

(52) U.S. Cl. 340/825.22

(57) ABSTRACT

A remote control system is disclosed, which radio transmits a control command from a remote controller to a receiving apparatus connected to an electronic device as an apparatus under control. The remote controller includes a radio communication section, a first storage section which stores identification information of the remote controller, a second storage section which stores identification information of another pairing party, an operation key, and a control section. The receiving apparatus includes a radio communication section, a first storage section which stores identification information of the receiving apparatus, a second storage section which stores identification information of another pairing party, a time management section, and a control section.

### CROSS REFERENCES TO RELATED APPLICATIONS

The present invention contains subject matter related to Japanese Patent Application JP 2007-212181 filed in the Japanese Patent Office on Aug. 16, 2007, the entire contents of which being incorporated herein by reference.

### BACKGROUND OF THE INVENTION

1. Field of the Invention

The present invention relates to a remote control system, a receiving apparatus, and an electronic device applied to remote controls for radio communication type electronic device.

2. Description of the Related Art

When a home-use apparatus under control (eg, a television receiver) is remotely controlled, if 2.4 GHz band ISM (Industrial, Scientific and Medical use) radio communication, for example, is used, it has advantages of less influence of obstructions and long communication range over infrared systems. In addition, if apparatus (eg, a digital versatile disc (DVD) reproducing apparatus, an AV amplifier, a projector) are disposed at different locations in one room like in a home theater system, it is bothersome for the user to direct their infrared remote controllers to their apparatus. In addition, if an apparatus is disposed outdoors, it is incapable of being directly controlled. In contrast, in radio type remote control systems (eg, BlueTooth, Instituted of Electrical and Electronics Engineers (IEEE) 802.15.4 (also called Zigbee), since radio waves are propagated at wide angles, they have an advantage of less restriction of installation locations of electronic devices over those systems.

Since these radio remote control systems are omnidirectional, when a radio remote controller transmits an operation command, it is difficult to determine what apparatus the remote controller is operating. Thus, it is necessary to correlate the remote controller with a desired electronic device in advance (this operation is referred to as pairing). Pairing means exchanging of identification information (IDs) of a remote controller and an apparatus under control. In particular, if there are other apparatus under control (each of which is composed of a receiving section and an electronic device) in the remote control system, it is necessary for the user to set his or her desired electronic device under control as a control target. As identification information, an ID (eg, an Message Authentication Code (MAC) address) assigned when an receiving apparatus was produced, an addresses created from a MAC address or the like is used.

The simplest method of performing pairing is to manually input identification codes to the remote controller and the receiving apparatus. However, in this method, since it is necessary to accurately input identification codes, this method imposes bothersome operations on the user.

The next considerable method is to use a cable (eg, a Universal Serial Bus (USB) cable) and exchange identification codes between a remote controller and a receiving apparatus when they are paired. In this method, although the user is freed from performing bothersome operations, it is necessary to provide a cable that is not used for communication along with the system. In addition, it is necessary for the user to keep the cable for the next pairing operations.

A technique of using a near range radio communication device along with a communication device used for ordinary communication and performing pairing with the near range radio communication device is described in Japanese Patent Application Laid-Open No. 2005-217646 publication.

### SUMMARY OF THE INVENTION

However, since remote control systems for many AV apparatus (eg, television receivers) are accomplished at very low cost, it is difficult to use a near range radio communication device for pairing in addition to a device used for ordinary communication from a view point of cost.

In view of the foregoing, it would be desirable to provide a remote control system, a receiving apparatus, and an electronic device that allow pairing to be simply performed without necessity of using a near range radio communication device for pairing.

According to an embodiment of the present invention, there is provided a remote control system which radio transmits a control command from a remote controller to a receiving apparatus connected to an electronic device as an apparatus under control. The remote controller includes a radio communication section, a first storage section which stores identification information of the remote controller, a second storage section which stores identification information of another pairing party, an operation key, and a control section. The receiving apparatus includes a radio communication section, a first storage section which stores identification information of the receiving apparatus, a second storage section which stores identification information of another pairing party, a time management section, and a control section. When the remote controller has issued a pairing start command, the remote controller causes the radio communication section to broadcast a pairing request containing the identification information of the remote controller. The receiving apparatus causes time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller. The remote controller which has received the pairing request response stores the identification information of the receiving apparatus as the identification information of the other pairing party to the second storage section.

According to an embodiment of the present invention, there is provided a receiving apparatus of a remote control system, the receiving apparatus being connected to an electronic device as an apparatus under control, a control command being radio transmitted from a remote controller to the receiving apparatus. The receiving apparatus includes a radio communication section, a first storage section which stores identification information of the receiving apparatus, a second storage section which stores identification information of another pairing party, a time management section, and a control section. The receiving apparatus causes the radio communication section to receive a pairing request containing identification information of the remote controller therefrom. The receiving apparatus causes the time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller.

According to an embodiment of the present invention, there is provided an electronic device as an apparatus under control having a receiving apparatus of a remote control system which transmits a control command from a remote controller to the receiving apparatus. The receiving apparatus includes a radio communication section, a first storage section which stores identification information of the receiving apparatus, a second storage section which stores identification information of another pairing party, a time management section, and a control section. The receiving apparatus causes the radio communication section to receive a pairing request containing identification information of the remote controller therefrom. The receiving apparatus causes time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller.

According to an embodiment of the present invention, there is provided a remote control system which radio transmits a control command from a remote controller to a receiving apparatus connected to an electronic device as an apparatus under control. The remote controller includes a radio communication section, a first storage section which stores identification information of the remote controller, a second storage section which stores identification information of another pairing party, an operation key, and a control section. The receiving apparatus includes a radio communication section, a first storage section which stores identification information of the receiving apparatus, a second storage section which stores identification information of another pairing party, a time management section, and a control section. The receiving apparatus causes the time management section to set a limited time which starts after power of the receiving apparatus is turned on and causes the radio communication section to broadcast a pairing request containing the identification information of the receiving apparatus. The remote controller which has received the pairing request stores the identification information of the receiving apparatus as the identification information of the other pairing party to the second storage section and causes the radio communication section to transmit a pairing request response containing the identification information of the remote controller to the receiving apparatus. If the receiving apparatus has received the pairing request response within the limited time, the receiving apparatus stores the identification information of the remote controller as the identification information of the other pairing party to the second storage section.

According to an embodiment of the present invention, there is provided a receiving apparatus of a remote control system, the receiving apparatus being connected to an electronic device as an apparatus under control, a control command being radio transmitted from a remote controller to the receiving apparatus. The receiving apparatus includes a radio communication section, a first storage section which stores identification information of the receiving apparatus, a second storage section which stores identification information of another pairing party, a time management section, and a control section. The receiving apparatus causes the time management section to set a limited time that start after power of the receiving apparatus is turned on and causes the radio communication section to broadcast a pairing request containing the identification information of the receiving apparatus. If the receiving apparatus has received a pairing request response containing identification information of the remote controller within the limited time from the remote controller that has received the pairing request, the receiving apparatus stores the identification information of the remote controller as the identification information of the other pairing party to the second storage section.

According to an embodiment of the present invention, there is provided an electronic device as an apparatus under control having a receiving apparatus of a remote control system which transmits a control command from a remote controller to the receiving apparatus. The receiving apparatus includes a radio communication section, a first storage section which stores identification information of the receiving apparatus, a second storage section which stores identification information of another pairing party, a time management section, and a control section. The receiving apparatus causes the time management section to set a limited time that starts after power of the receiving apparatus is turned on and causes the radio communication section to broadcast a pairing request containing the identification information of the receiving apparatus. If the receiving apparatus has received a pairing request response containing identification information of the remote controller within the limited time from the remote controller which had received the pairing request, the receiving apparatus stores the identification information of the remote controller as the identification information of the other pairing party to the second storage section.

According to an embodiment of the present invention, if a pairing request is received within a predetermined limited time after power of a receiving apparatus has been turned on, the pairing request is validated and pairing is performed. In addition, according to an embodiment of the present invention, if a pairing request response is received within a predetermined limited time after power of a receiving apparatus has been turned on, the pairing request response is validated and pairing is performed. Thus, since it is not necessary to use a near range radio communication device for pairing, a low cost structure can be used. In addition, it is not necessary for the user to perform bothersome operations for pairing. In addition, in an environment of multiple electronic devices, the other pairing party can be changed by changing power-on timing.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1A and FIG. 1B are block diagrams showing structures of a remote controller and a reception module;

FIG. 2 is a schematic diagram describing an environment in which a remote control system according to an embodiment of the present invention is applied;

FIG. 3 is a flow chart describing a pairing process according to an embodiment of the present invention;

FIG. 4 is a timing chart describing a pairing process according to an embodiment of the present invention;

FIG. 5 is a timing chart describing a pairing process according to an embodiment of the present invention;

FIG. 6 is a block diagram showing a structure of a transmission side for remote control; and

FIG. 7 is a block diagram showing a structure of a reception side for remote control.

### DETAILED DESCRIPTION OF THE PREFERRED EMBODIMENTS

Next, with reference to the accompanying drawings, an embodiment of the present invention will be described. An embodiments of the present invention is applied to a remote control system that remotely controls home electronic devices. A remote control system is composed of one transmitting apparatus (sometimes referred to as a remote controller) that transmits remote control command data (hereinafter sometimes referred to as a command) corresponding to a user's operation and at least one apparatus under control (a receiving apparatus and an electronic device) that receives a transmitted command and performs a commanded operation.

The electronic devices are television receivers, video recording/reproducing apparatus (specifically including Digital Versatile Disc (DVD) players, disc recorders, and Video Cassette Recorders (VCRs)), audio recording/reproducing apparatus (specifically including CD players, MD recorders, audio amplifiers, and FM tuners), AV apparatus (including projectors), and home electric appliances (including refrigerators). The remote controller is driven by its built-in power supply and the electronic device is driven, for example, by a commercial power.

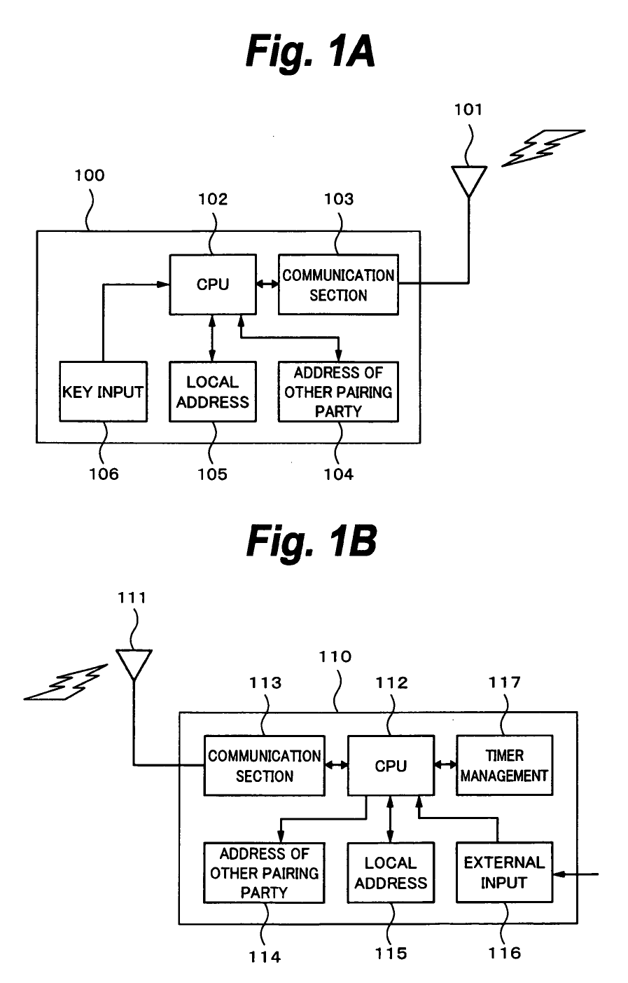

As shown in FIG. 1A, the remote controller (designated by reference numeral 100) has an antenna 101 that transmits and receives radio waves; a microprocessor (hereinafter referred to as the Central Processing Unit (CPU)) 102 as a control section that performs a communication function, address read/write operations for storage mediums, and executes programs corresponding to various types of key inputs; a communication section 103 that performs radio communication; a storage medium 104 that stores an identification code (eg, a MAC address) of the other pairing party; a storage medium 105 that stores an identification code (eg, a MAC address) of the remote controller 100; and a key input section 106 that has keys corresponding to various types of commands including a pairing start command. The storage medium 104 and 105 are composed, for example, of non-versatile memories. The CPU 102 includes a Read Only Memory (ROM) and a Random Access Memory (RAM). The CPU 102 executes programs stored in the ROM and so forth and thereby totally controls each section of the remote controller 100.

As shown in FIG. 1B, a receiving apparatus of the remote control system (the receiving apparatus is designated by reference numeral 110 and hereinafter sometimes referred to as the receiving module) has an antenna 111 that transmits and receives radio waves; a CPU 112 that performs a communication function, read/write operations for address storage mediums, and executes programs corresponding to various types of key inputs; a communication section 113 that performs radio communication; a storage medium 114 that stores an identification code (eg, a MAC address) of the other pairing party; a storage medium 115 that stores an identification code (eg, a MAC address) of the local apparatus; an external input section 116 that detects a power state of an externally connected apparatus (eg, a television receiver) and informs the CPU 112 of the detected state; and a timer management section 117. The CPU 112 totally controls each section of the receiving module 110. The storage mediums 114 and 115 are composed, for example, of non-volatile memories. The timer management section 117 has a counter. When power of the electronic device is turned on through the external input section 116, the counter is reset and incremented at intervals of one second.

The communication section 103 of the remote controller 100 and the communication section 113 of the receiving module 110 bidirectionally communicate with each other according to a predetermined radio communication system. As the communication system, BlueTooth, IEEE 802.15.4, IEEE 802.11 (wireless LAN), or the like can be used. The external input section 116 has a function of outputting a received command through radio remote control to the connected electronic device.

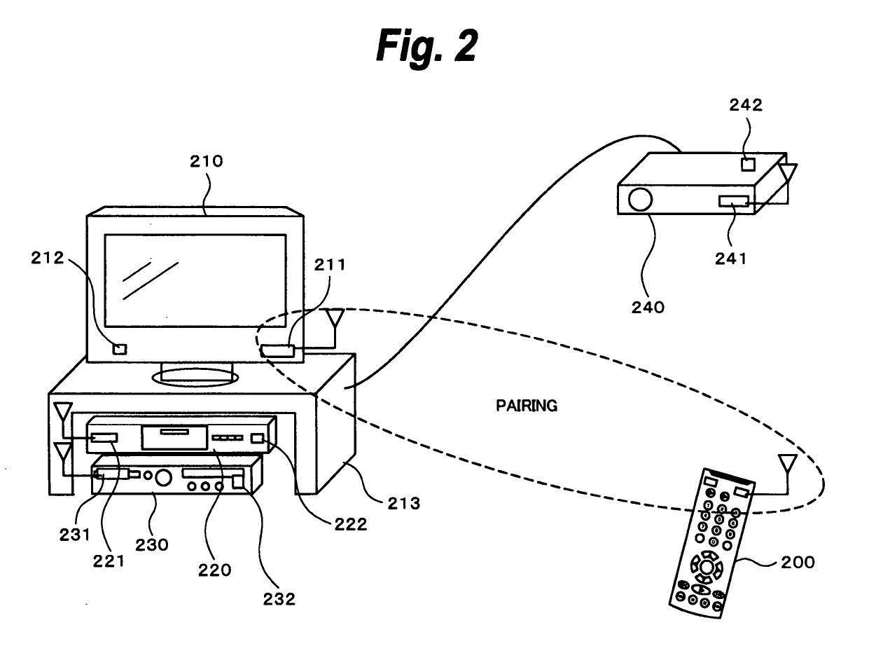

FIG. 2 shows an example of an audio visual system (audio visual environment) according to an embodiment of the present invention. A receiving module 211 is connected to a television receiver 210. The receiving module 211 supplies a received remote control signal to an internal system controller of the television receiver 210 and transmits a transmission signal as a radio wave. A power button 212 is disposed on the television receiver 210.

In addition to the television receiver 210, other AV apparatus are disposed in the same room. In addition to the television receiver 210, a DVD reproducing apparatus 220 and an AV amplifier 230 are disposed in an AV rack 213. A receiving module 221 is mounted on the DVD reproducing apparatus 220, a receiving module 231 is mounted on the AV amplifier 230, and a receiving module 241 is mounted on a projector 240. The DVD reproducing apparatus 220 has a power button 222, the AV amplifier 230 has a power button 232, and the projector 240 has a power button 242.

A remote controller 200 has the same structure as the remote controller 100 shown in FIG. 1A. The receiving modules 211, 221, 231, and 241 have the same structure as the receiving module 110 shown in FIG. 1B. The individual electronic devices operate in one of power-on mode and power-off mode corresponding to the operations of the power buttons 212, 222, 232, and 242.

Power is always supplied to the receiving modules 211, 221, 231, and 241 mounted to the respective electronic devices regardless of the positions of their power buttons. However, when a main power switch of each electronic device is turned off, power to the receiving module is stopped. Each receiving module can detect the current operation mode (power-on state or power-off state) of each electronic device connected through the external input section 116.

The receiving modules 211, 221, 231, and 241 are separately produced as components added to individual electronic devices. When each receiving module is produced, its unique MAC address is assigned thereto. Likewise, when the remote controller 200 is produced, its unique MAC address is assigned thereto. The remote controller 200 performs pairing with, for example, the receiving module 211 of the television receiver 210.

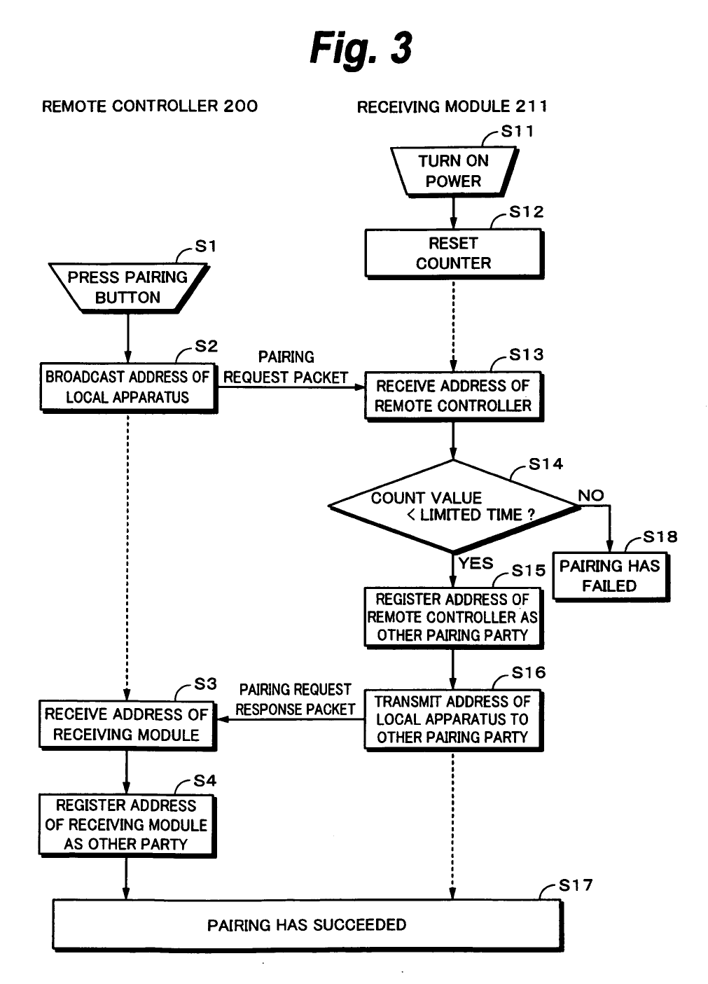

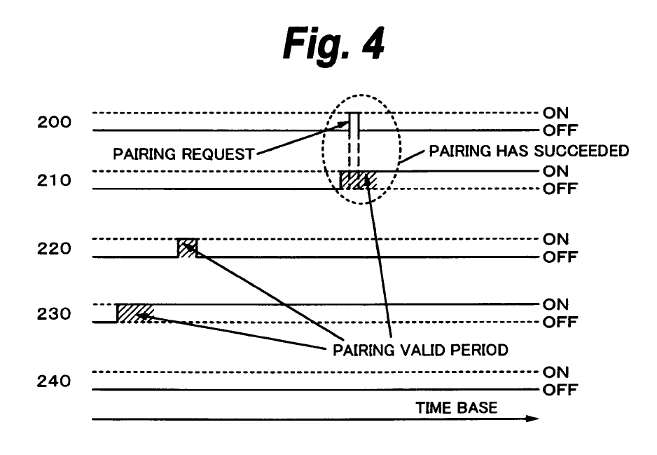

Next, with reference to FIG. 3 and FIG. 4, the pairing operation will be described. In a flow chart shown in FIG. 3, steps S1 to S4 are processes of the remote controller 200. Steps S11 to S16 are processes of the receiving module 211 mounted on the television receiver 210. The processes of the remote controller 200 are executed under the control of the CPU 102. The processes of the remote controller 200 are performed under the control of the CPU 112.

When the user turns on the power button 212 of the television receiver 210, the CPU 112 is informed as an interrupt through the external input section 116 of the receiving module that the power mode has been changed from the off state to the on state (at step S11). At step S12, the CPU 112 controls the timer management section 117 to reset the counter. Thereafter, the count value is incremented at intervals of one second. This sequence of processes is performed as a pairing ready phase of the receiving module 211.

After power of the television receiver 210 has been turned on, a pairing start key of the key input section 106 is pressed on the remote controller 200 (at step S1). Instead, a particular key may be assigned as the pairing start key. Instead, a combination of a plurality of keys may be assigned as the pairing start key operation.

The CPU 102 is informed that a key input of the pairing start key occurred. The CPU 102 reads the address of the local apparatus from the storage medium 105. A pairing request packet that has this address as a sender address is created as a broadcast packet. A broadcast packet is a destination nonspecific packet that all receiving modules in the radio wave communication range can receive. At step S2, the pairing request packet is transmitted to all the receiving modules through the communication section 103 and the antenna 101.

A packet is normally composed of a header and a payload. A sender address, a destination address, and so forth are inserted into the header. A command ID that represents the type of a command and a command itself are inserted into the payload. A pairing request packet and a pairing request response packet that will be described later are identified by command IDs. These packets do not necessarily contain a command for an electronic device. The payload of a packet transmitted to the receiving module 211 from the remote controller 200 after pairing has succeeded contains a command ID and a command itself. For a signal format for commands, a format similar to that for an ordinary infrared remote controller is used.

At step S13, the receiving module 211 receives the pairing request packet and extracts the address of the sender (remote controller 200) therefrom. At step S14, the count value of the counter is compared with a limited time. The count value is a value of the counter after the pairing request packet is received and the process of step S13 is completed. The limited time is a preset time of around several ten seconds.

If the determined result at step S14 denotes that the count value is equal to or larger than the limited time, the flow advances to step S18. At step S18, it is determined that pairing have failed. In other words, if the count value is equal to or larger than the limited time, it is determined that the pairing request packet designated to another receiving module have been coincidentally received by the local receiving module and no further process is performed.

If the determined result at step S14 denotes that the count value is smaller than the limited time, the flow advances to step S15. At step S15, the extracted sender address (remote controller) is registered as the other pairing party.

In addition, the CPU 112 reads the address of the local apparatus from the storage medium 115, creates a pairing request response packet that contains the address of the other pairing party as the destination address and the address of the local apparatus, and transmits the pairing request response packet through the communication section 113 and the antenna 111.

At step S3, the remote controller 200 that has received the packing request response packet extracts the address of the receiving module 211. At step S4, the remote controller 200 registers the extracted address of the receiving module 211 as the other pairing party to the storage medium 104.

In these processes, the addresses of the remote controller 200 and the receiving module 211 have been registered as the addresses of the parties. Thus, thereafter, commands are exchanged in the pairing state in which their parties are identified (at step S17).

As shown in FIG. 4, since the pairing request packet has been received from the remote controller 200 within the limited time (being hatched) after power of the television receiver 210 had been turned on, pairing of the DVD reproducing apparatus 220 and the AV amplifier 230 succeeds. In contrast, since the DVD reproducing apparatus 220 and the AV amplifier 230 have not received the pairing request packet within the limited time after power of the television receiver 210 had been turned on, pairing fails. In addition, since power of the projector 240 has been turned off, pairing fails.

In such a manner, the receiving module 211 of the television receiver 210 is determined to be the other pairing party. As with the above processes, with respect to the other apparatus, the DVD reproducing apparatus 220, the AV amplifier 230, and the projector 240, when a pairing request packet is transmitted from the remote controller 200 within the limited time after power of each apparatus has been turned on, pairing can be performed. Instead, pairing may be performed between each electronic device and its dedicated remote controller.

In the foregoing embodiment of the present invention, the receiving module 110 has the external input section 116, detects the power change of the electronic device connected thereto, and performs a counter reset process of the timer management section 117. Instead, with a trigger that denotes that power has been supplied, the CPU 112 of the receiving module 110 may perform the counter reset process. In this structure, since an interface (eg, the external input section 116) disposed between a receiving module and a device connected thereto can be omitted, the structure can be more easily implemented than the foregoing embodiment.

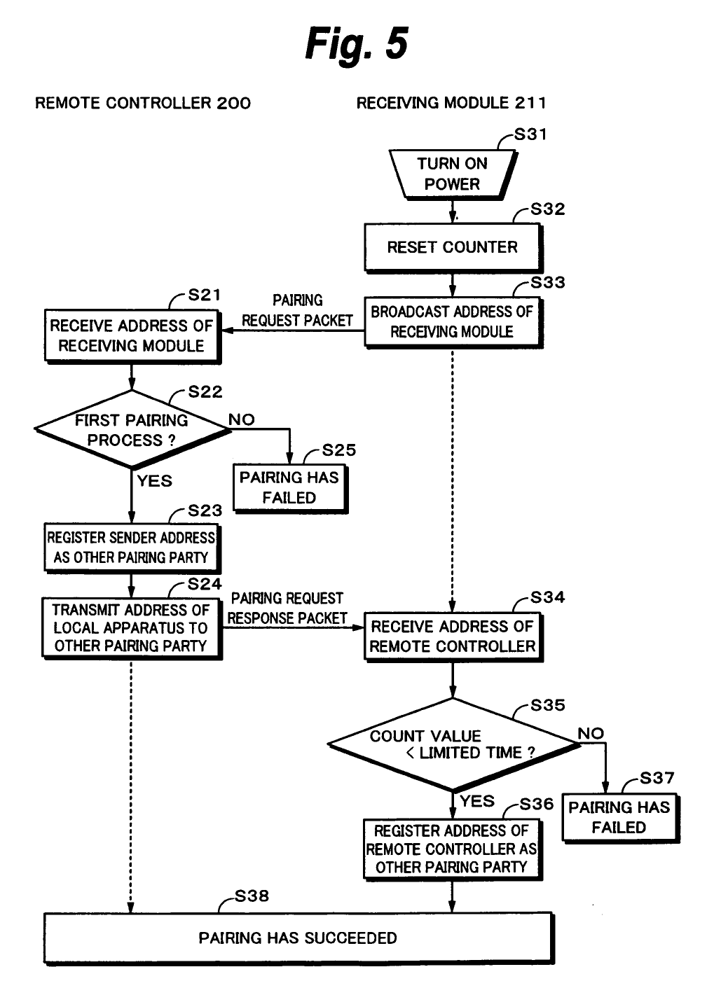

Next, with reference to a flow chart shown in FIG. 5, another embodiment of the present invention will be described. In this embodiment, since a receiving module broadcasts a pairing request packet, an operation of pressing a pairing start button on a remote controller is omitted. In the foregoing embodiment, it is assumed that the remote controller 200 is connected to one or a plurality of electronic devices as pairing parties. In contrast, in this embodiment, the pairing process can be performed without a user's intervention.

When the user presses the power button 212 of the television receiver 210, the CPU 112 detects that the power state has changed from the off state to the on state (at step S31). At step S32, the CPU 112 controls the timer management section 117 to reset the counter and increment the counter at intervals of one second. This sequence of processes is the same as that of the foregoing embodiment.

Thereafter, at step S33, the CPU 112 of the receiving module 110 reads the address of the receiving module 110 from the storage medium 115, creates a pairing request packet that contains this sender address as a broadcast packet, and broadcasts the pairing request packet.

The remote controller 200 receives the packet (at step S21). At step S22, the CPU 102 of the remote controller 200 determines whether or not the sender address extracted from the received pairing request packet exists as the address of the other pairing party stored in the storage medium 104.

If the sender address exists as the address of the other pairing party, it means that this pairing process is not the first pairing process. The pairing process is stopped and it is determined that pairing has failed (at step S25).

If the sender address does not exist as the address of the other pairing party, it means that this pairing process is the first pairing process. At step S23, the address of the electronic device of the other party is extracted from the pairing request packet and registered to the storage medium 104. At step S24, a pairing request response packet that contains the address of the local apparatus as a sender address read from the storage medium 105 is transmitted to the electronic device of the other pairing party.

The receiving module 211 of the television receiver 210 receives the pairing request response packet containing the address of the remote controller 200 as the sender address and extracts the address of the remote controller 200 from the pairing request response packet (at step S34).

The receiving module 211 receives the pairing request response packet and detects the count value of the counter at which the address extracting process was performed. At step S35, the count value is compared with a limited time. The limited time is a preset time for around several ten seconds.

If the determined result at step S35 denotes that the count value is equal to or larger than the limited time, the flow advances to step S37. At step S37, it is determined that pairing have failed. In contrast, if the determined result at step S35 denotes that the count value is smaller than the limited time, the flow advances to step S36. At step S36, the extracted sender address (remote controller) is registered as the other pairing party to the storage medium 114.

In these processes, the addresses of the remote controller 200 and the receiving module 211 have been registered as the addresses of the parties. Thus, thereafter, commands are exchanged in the pairing state in which their parties are identified (at step S38).

To the method of limiting the other pairing party based on the foregoing limited time, a method of limiting the other pairing party based on a limited distance using the intensity of a received radio wave may be added. Assuming that the intensity of a radio wave transmitted from the antenna of the remote controller 200 that transmits a pairing request is constant, the intensity of the radio wave that an electronic device that is close to the remote controller 200 receives is larger than the intensity of the radio wave that another electronic device that is far from the remote controller 200 receives. Using the relationship of the intensity of radio wave and the distance, a condition of which the other pairing party is limited to an electronic device that is close to the remote controller is added to the limited time. For example, at the determination step S14 (FIG. 3) of the foregoing embodiment, a condition of which only a pairing request packet that is received as a radio wave having an intensity larger than a predetermined value is permitted as that for the other pairing party is added.

Such a pairing limitation based on the intensity of radio waves is effective in the case that the communication range of the radio waves is wide and pairing with another electronic device of a neighborhood house is prevented from being mistakenly performed like IEEE 802.15.4 or a wireless LAN. In addition, to obtain the similar effect, the intensity of radio waves that are transmitted for a pairing request may be decreased.

The communication section 103 of the remote controller 100 and the communication section 113 of the receiving module 110 may use the physical layer of IEEE 802.15.4. IEEE 802.5.4 is the name of a short range radio network standard called Personal Area Network (PAN) or Wireless PAN (WPAN).

The communication rate of this standard is in the range from several 10 kbps to several 100 kbps. The communication distance is in the range from several 10 m to several 100 m. In addition, communication is made frame by frame. One frame has a maximum of 133 bytes of a pay load (0 to 127 bytes) and a header (6 bytes). In this communication system, although a plurality of transmission and reception methods can be used, a method of which the remote controller transmits a command to the receiving module and the remote controller receives a response from the receiving module is used. Instead, a more complicated transmission and reception method may be used.

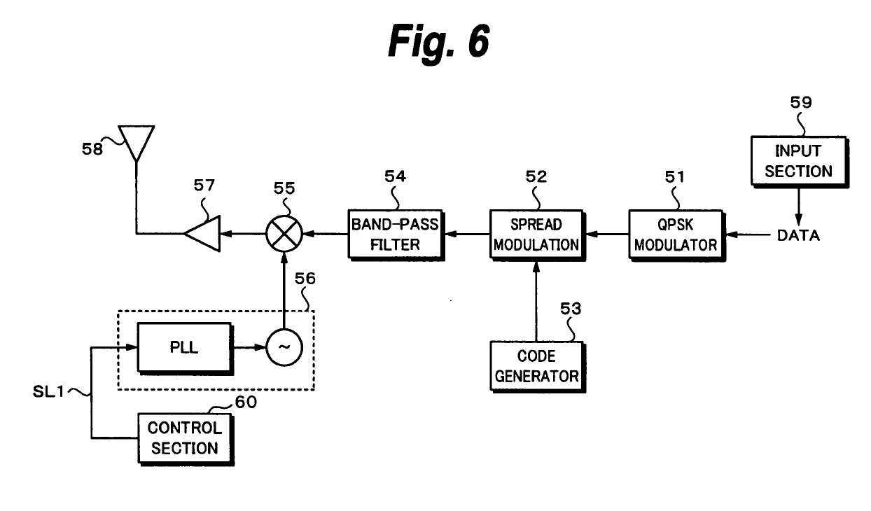

FIG. 6 shows the structure of transmitters included in the communication sections 103 and 113.

Transmission data are supplied to a Quadrature Phase Shift Keying (QPSK) modulator 51 that modulates the transmission data according to the QPSK system. An output signal of the QPSK modulator 51 is supplied to a spread spectrum modulator 52. A spread code generated by a code generator 53 is supplied to the spread spectrum modulator 52. The spread spectrum modulator 52 spreads the supplied spectrum code according to the Direct Sequence Spread Spectrum (DSSS) system. As the spread code, a pseudo noise sequence is used. The Direct Spread (DS) system is an Spectrum Spread (SS) system of which phase modulation is performed with a high speed spread code to spread the spectrum of the signal.

An output signal of the spread spectrum modulator 52 is supplied to a multiplying device 55 through a band-pass filter 54. Supplied to the multiplying device 55 is a local oscillation signal supplied from a local oscillator 56 having the structure of a Phase Lock Loop (PLL). The multiplying device 55 generates a transmission signal that has been up-converted into a 2.4 GHz frequency band. The transmission signal is supplied to an antenna 58 through an amplifier 57 and then transmitted. The transmission output can be changed by controlling the gain of the amplifier 57.

Sixteen communication channels are set starting from 2.405 GHz at intervals of 5 MHz (ie, 2.410 GHz, 2.415 GHz, . . . 2.480 GHz). In this embodiment, a plurality of frequency channels (eg, three frequency channels) that do not overlap with frequencies for the wireless LAN are used in these 16 frequency channels. A channel is set by adjusting the local oscillation frequency that the local oscillator 56 outputs with a channel selection signal SL1. The selection signal SL1 is output from a control section 60.

The control section 60 is a microcomputer composed, for example, of a CPU, a ROM, a RAM, and so forth. The control section 60 totally controls each section of the transmitter by executing programs stored in the ROM or the like.

Disposed in the transmitter of the remote controller is an input section 59 that includes keys, switches, buttons and/or a touch panel to remotely control an electronic device. A command corresponding to an operation to the input section 59 is transmitted to the electronic device. If the electronic device has normally received the command, the electronic device transmits a response to the remote controller.

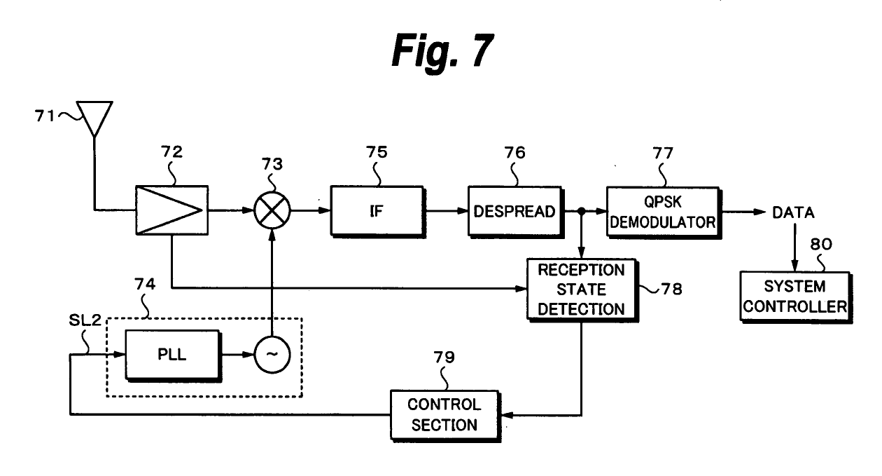

FIG. 7 shows the structure of the receivers contained in the communication sections 103 and 113. A signal received by an antenna 71 is supplied to a Low Noise Amplifier (LNA) 72. The antenna 71 is normally used in common with the antenna 58 of the transmitter. The transmitter or the receiver is selected by a transmission and reception selection switch. An output signal of the LNA 72 is supplied to a multiplying device 73. A local oscillation signal is supplied from a local oscillator 74 having the structure of a PLL to the multiplying device 73. The multiplying device 73 generates a down-converted Intermediate Frequency (IF) signal.

The IF signal is supplied to a spread spectrum demodulator 76. The spread spectrum demodulator 76 demodulates the reception signal by correlating the reception signal with a reference spread code generated on the reception side. If the timings of the reception signal and the reference spread code do not accurately match, a correct correlation value is not obtained. When communication starts, the reception side finds the timings and holds the found timing. To find the timings, a correlator (eg, a matched filter) is used.

A demodulation signal is supplied from the spread spectrum demodulator 76 to a QPSK demodulator 77. The QPSK demodulator 77 demodulates the supplied signal according to the QPSK system and obtains reception data. In the electronic device, the reception data are a command. The command is supplied to a system controller 80 of the electronic device. The command is used to control the operation of the electronic device. In the remote controller, the reception data are a response and the received response is supplied to a control section 79.

The control section 79 is a microcomputer composed, for example, of a CPU, a ROM, a RAM, and so forth. The control section 79 totally controls each section of the receiver by executing programs stored in the ROM or the like. Specifically, the control section 60 of the transmitter and the control section 79 of the receiver are structured in common. The CPU 102 shown in FIG. 1A or the CPU 112 shown in FIG. 1B corresponds to the control section 60 or 79, respectively.

The demodulation signal supplied from the spread spectrum demodulator 76 and the output signal of the LNA 72 are supplied to a reception state detection section 78. The reception state detection section 78 has functions of receiving a frame (eg, a pairing request signal), calculating a Link Quality Indicator (LQI) based on the intensity of the signal and the intensity of the noise interference, and informing the upper level of the physical layer of LQI. LQI is specified in the physical layer of IEEE 802.15.4 and represented as the value of digital data. LQI is the value corresponding to the error rate. LQI is supplied to the control section 79. LQI calculated by the reception state detection section 78 of the receiver of the electronic device is transmitted to the remote controller along with the response.

A channel selection signal SL2 that the control section 79 generates controls the local oscillator 74 and causes a predetermined frequency channel that is less affected by the microwave oven to be selected from a plurality of different frequency channels.

It should be understood by those skilled in the art that various modifications, combinations, sub-combinations and alternations may occur depending on design requirements and other factors insofar as they are within the scope of the appended claims or the equivalents thereof. For example, the radio communication method may be based on other than IEEE 802.15.4.

What is claimed is:

1. A remote control system which radio transmits a control command from a remote controller to a receiving apparatus connected to an electronic device as an apparatus under control,
the remote controller comprising:
a radio communication section;
a first storage section which stores identification information of the remote controller;
a second storage section which stores identification information of another pairing party;
an operation key; and
a control section,
the receiving apparatus comprising:
a radio communication section;
a first storage section which stores identification information of the receiving apparatus;
a second storage section which stores identification information of another pairing party;
a time management section; and
a control section,
wherein when the remote controller has issued a pairing start command, the remote controller causes the radio communication section to broadcast a pairing request containing the identification information of the remote controller,
the receiving apparatus causes time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller, and
the remote controller which has received the pairing request response stores the identification information of the receiving apparatus as the identification information of the other pairing party to the second storage section.

2. The remote control system as set forth in claim 1,
wherein the remote controller broadcasts the pairing request corresponding to an operation of the operation key.

3. The remote control system as set forth in claim 1,
wherein the limited time which starts after the power of the electronic device connected to the receiving apparatus is turned on is set by the time management section.

4. The remote control system as set forth in claim 1,
wherein the limited time which starts after the power of the control section of the receiving apparatus is turned on is set by the time management section.

5. The remote control system as set forth in claim 1,
wherein if the receiving apparatus has received the pairing request within the limited time and with an intensity of a radio wave which is equal to or larger than a predetermined level, the receiving apparatus stores the identification information of the remote controller as the identification information of the other pairing party to the second storage section.

6. A receiving apparatus of a remote control system, the receiving apparatus being connected to an electronic device as an apparatus under control, a control command being radio transmitted from a remote controller to the receiving apparatus, comprising:
a radio communication section;
a first storage section which stores identification information of the receiving apparatus;
a second storage section which stores identification information of another pairing party;
a time management section; and
a control section,
wherein the receiving apparatus causes the radio communication section to receive a pairing request containing identification information of the remote controller therefrom, and
the receiving apparatus causes the time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller.

7. An electronic device as an apparatus under control having a receiving apparatus of a remote control system which transmits a control command from a remote controller to the receiving apparatus, comprising:
a radio communication section;
a first storage section which stores identification information of the receiving apparatus;
a second storage section which stores identification information of another pairing party;
a time management section; and
a control section,
wherein the receiving apparatus causes the radio communication section to receive a pairing request containing identification information of the remote controller therefrom, and
the receiving apparatus causes time management section to set a limited time which starts after power of the receiving apparatus is turned on, if the receiving apparatus has received the pairing request within the limited time, the receiving apparatus stores the identification information of the remote controller as the identification information of the other pairing party to the second storage section, and causes the radio communication section to transmit a pairing request response containing the identification information of the receiving apparatus to the remote controller.

8. A remote control system which radio transmits a control command from a remote controller to a receiving apparatus connected to an electronic device as an apparatus under control,
the remote controller comprising:
a radio communication section;
a first storage section which stores identification information of the remote controller;
a second storage section which stores identification information of another pairing party;
an operation key; and
a control section,
the receiving apparatus comprising:
a radio communication section;
a first storage section which stores identification information of the receiving apparatus;
a second storage section which stores identification information of another pairing party;
a time management section; and
a control section,
wherein the receiving apparatus causes the time management section to set a limited time which starts after power of the receiving apparatus is turned on and causes the radio communication section to broadcast a pairing request containing the identification information of the receiving apparatus,
the remote controller which has received the pairing request stores the identification information of the receiving apparatus as the identification information of the other pairing party to the second storage section and causes the radio communication section to transmit a pairing request response containing the identification information of the remote controller to the receiving apparatus, and
if the receiving apparatus has received the pairing request response within the limited time, the receiving apparatus stores the identification information of the remote controller as the identification information of the other pairing party to the second storage section.

9. A receiving apparatus of a remote control system, the receiving apparatus being connected to an electronic device as an apparatus under control, a control command being radio transmitted from a remote controller to the receiving apparatus, comprising:
a radio communication section;
a first storage section which stores identification information of the receiving apparatus;
a second storage section which stores identification information of another pairing party;
a time management section; and
a control section,
wherein the receiving apparatus causes the time management section to set a limited time that start after power of the receiving apparatus is turned on and causes the radio communication section to broadcast a pairing request containing the identification information of the receiving apparatus, and
if the receiving apparatus has received a pairing request response containing identification information of the remote controller within the limited time from the remote controller that has received the pairing request, the receiving apparatus stores the identification information of the remote controller as the identification information of the other pairing party to the second storage section.

10. An electronic device as an apparatus under control having a receiving apparatus of a remote control system which transmits a control command from a remote controller to the receiving apparatus, comprising:
a radio communication section;
a first storage section which stores identification information of the receiving apparatus;
a second storage section which stores identification information of another pairing party;
a time management section; and
a control section,
wherein the receiving apparatus causes the time management section to set a limited time that starts after power of the receiving apparatus is turned on and causes the radio communication section to broadcast a pairing request containing the identification information of the receiving apparatus, and
if the receiving apparatus has received a pairing request response containing identification information of the remote controller within the limited time from the remote controller which had received the pairing request, the receiving apparatus stores the identification information of the remote controller as the identification information of the other pairing party to the second storage section.
